(19) United States
(12) Patent Application Publication
(10) Pub. No.: US 2026/0221841 A1
(43) Pub. Date: Jul. 30, 2026

(54) EXTERNAL ROTOR MOTOR

(71) Applicant: ZHONGSHAN BROAD-OCEAN MOTOR CO., LTD, Zhongshan, Guangdong (CN)

(72) Inventors: Liewei GUO, Zhongshan (CN); Chao GUAN, Zhongshan (CN); Tingshuai HUANG, Zhongshan (CN)

(21) Appl. No.: 19/146,708

(22) PCT Filed: Mar. 11, 2024
(86) PCT No.: PCT/CN2024/081043

§ 371 Date: Jul. 9, 2025

(30) Foreign Application Priority Data
Dec. 7, 2023 (CN) 202311679096.4

(51) Int. Cl. H02K 9/06; H02K 5/173; H02K 5/18; H02K 5/20; H02K 7/08; H02K 21/22

(52) U.S. Cl. CPC H02K 9/06; H02K 5/1735; H02K 5/18; H02K 5/207; H02K 7/085; H02K 21/22; H02K 2205/09

(57) ABSTRACT

Disclosed in the present invention is an external rotor motor, including a rotation shaft, a stator assembly, an external rotor assembly, and a bearing seat. The stator assembly is sheathed and mounted on an exterior of a sleeve. The external rotor assembly is sleeved around an exterior of the stator assembly. The external rotor assembly includes a housing and a plurality of permanent magnets. The stator assembly is located in the housing. An upper end portion fan and a lower end portion fan are respectively mounted on an upper side and a lower side of the permanent magnets of the stator assembly. The upper end portion fan includes an upper wind shield and a plurality of upper guide vanes protruding from the upper wind shield. The lower end portion fan includes a lower wind shield and a plurality of lower guide vanes protruding from the lower wind shield. A plurality of ventilation holes are further provided in the lower wind shield. The upper guide vanes and the lower guide vanes both face the stator assembly and are staggered in a circumferential direction, so that when the upper end portion fan and the lower end portion fan rotate together with the external rotor assembly, air circulation is formed between an upper end and a lower end inside the motor, thereby effectively solving failure risks caused by non-uniform temperature rise in stator windings; and no ventilation holes are opened outside the motor, so that the motor has high protection performance.

### TECHNICAL FIELD

The present invention relates to an external rotor motor.

### BACKGROUND

The applicant filed a utility model patent application entitled “EXTERNAL ROTOR MOTOR WITH NOVEL COOLING STRUCTURE” (Application No. 202122810211.X) on Nov. 17, 2021. In this patent, a plurality of ventilation holes are opened at the top of the housing of the external rotor assembly. While this patent addresses ventilation and cooling issues, the protection rating is degraded.

For an external rotor motor with a high protection rating requirement and a large power density, to ensure the protection rating of the motor, no ventilation holes can be opened in the housing of the external rotor assembly, and a tight fit is required between the external rotor assembly and the bearing seat. As a result, the entire stator assembly is in a closed environment, and heat in the stator assembly cannot be dissipated through air convection, and heat generated by stator windings and core losses during operation can only be conducted outside the motor through the bearing seat fitted with the stator assembly. However, the bearing seat has a limited conduction area and an insufficient heat conduction capability. As the losses gradually increase, heat in the stator windings and the core cannot be effectively conducted outside in time, and gradient temperatures are generated in the stator assembly from top to bottom, that is, the temperature of a stator winding far away from the bottom of the bearing seat is significantly higher than that of a stator winding close to the bearing seat, and the temperature of a coil winding of the stator is far higher than the temperature at the bottom of the bearing seat. (The measurement of a 15HP high-power motor is used as an example. A temperature rise of a coil winding at the top of a bearing seat is 25K higher than a coil winding at the bottom of the bearing seat, and is 50K higher than that at the bottom of the bearing seat).

A schematic diagram of specific heat transfer is shown in FIG. 1. Arrows in the figure indicate a contact heat transfer path. A specific heat conduction path is: the coil windings→the bearing seat (from top to bottom)→the bottom of the bearing seat (from the interior to the exterior)→ambient air outside the motor. The heat finally needs to be conducted between the cooling ribs at the bottom of the bearing seat and external cool air. As a result, a coil winding closer to the bottom of the bearing seat has better cooling, and a coil winding farther away from the bottom of the bearing seat has poorer cooling, eventually causing a large difference between temperature rises at two ends of coil windings within the same slot.

### SUMMARY OF THE INVENTION

The present invention provides an external rotor motor, to solve the technical problems in the related art that for an external rotor motor with a high protection rating requirement, because a rotor housing is sealed at the top (no ventilation holes are opened), air circulation cannot form in inside the motor, cooling is slow, and a large difference exists between temperature rises at two ends of coil windings within the same slot in a stator assembly.

The technical solution of the present invention is implemented as follows.

The present invention provides an external rotor motor, including a rotation shaft, a stator assembly, an external rotor assembly, and a bearing seat, where the bearing seat includes a bottom plate and a sleeve protruding upward from the center of the bottom plate, a bearing is mounted inside the sleeve, the rotation shaft is supported on the bearing, the stator assembly is sheathed and mounted on an exterior of the sleeve, the external rotor assembly is sleeved around an exterior of the stator assembly, the external rotor assembly includes a housing, the housing includes a top plate and a cylindrical side plate that are connected together, a plurality of permanent magnets are mounted on an inner wall surface of the cylindrical side plate, the top plate and the cylindrical side plate enclose a cavity, the stator assembly is located in the cavity, an end of the rotation shaft is connected to the top plate, and an upper end portion fan and a lower end portion fan are respectively mounted on an upper side and a lower side of the permanent magnets;
the upper end portion fan includes an upper wind shield and a plurality of upper guide vanes protruding from the upper wind shield, an upper central hole is provided at the center of the upper wind shield, and the plurality of upper guide vanes are circumferentially distributed around a partial circumference of a periphery of the upper central hole;
the lower end portion fan includes a lower wind shield and a plurality of lower guide vanes protruding from the lower wind shield, a lower central hole is provided at the center of the lower wind shield, a plurality of ventilation holes are further provided in the lower wind shield, and the plurality of ventilation holes and the plurality of lower guide vanes are circumferentially distributed around a periphery of the lower central hole; and
the plurality of upper guide vanes and the plurality of lower guide vanes both face the stator assembly and are staggered in a circumferential direction, so that when the upper end portion fan and the lower end portion fan rotate together with the external rotor assembly, air circulation is formed between an upper end and a lower end inside the motor to accelerate cooling.

An upper flange ring protrudes axially from an edge of the upper wind shield, and a plurality of circumferentially spaced upper inserts protrude axially from a surface of the upper flange ring; a lower flange ring protrudes axially from an edge of the lower wind shield, and a plurality of circumferentially spaced lower inserts protrude axially from a surface of the lower flange ring; and every two adjacent permanent magnets are separated by one upper insert and one lower insert, and the upper end portion fan and the lower end portion fan are located in the cavity.

The plurality of upper guide vanes are circumferentially distributed around a 180-degree partial circumference of the periphery of the upper central hole, and the remaining 180-degree partial circumference of the periphery of the upper central hole is void of vanes; and the plurality of lower guide vanes are circumferentially distributed around a 180-degree partial circumference of the periphery of the lower central hole, and the plurality of ventilation holes are distributed around the remaining 180-degree partial circumference of the periphery of the lower central hole.

A mounting seat protrudes from the center of the top plate to the cavity, and the end of the rotation shaft extends from the sleeve to be connected to the mounting seat.

At least two ventilation holes are provided.

The upper guide vanes and the lower guide vanes have opposite curvature directions.

A plurality of cooling ribs protrude from the bottom plate.

The cooling ribs include internal cooling ribs and external cooling ribs, the internal cooling ribs are located under the housing, the external cooling ribs are located at a periphery of the internal cooling ribs, and the internal cooling ribs are shaped in a plurality of concentric circles with the sleeve as the center thereof.

The plurality of external cooling ribs are arranged to extend radially with the sleeve as the center thereof.

The present invention has the following advantages as compared with the related art:

1. The external rotor motor includes a rotation shaft, a stator assembly, an external rotor assembly, and a bearing seat, where the bearing seat includes a bottom plate and a sleeve protruding upward from the center of the bottom plate, a bearing is mounted inside the sleeve, the rotation shaft is supported on the bearing, the stator assembly is sheathed and mounted on an exterior of the sleeve, the external rotor assembly is sleeved around an exterior of the stator assembly, the external rotor assembly includes a housing, the housing includes a top plate and a cylindrical side plate that are connected together, a plurality of permanent magnets are mounted on an inner wall surface of the cylindrical side plate, the top plate and the cylindrical side plate enclose a cavity, the stator assembly is located in the cavity, an end of the rotation shaft is connected to the top plate, and an upper end portion fan and a lower end portion fan are respectively mounted on an upper side and a lower side of the permanent magnets; the upper end portion fan includes an upper wind shield and a plurality of upper guide vanes protruding from the upper wind shield, an upper central hole is provided at the center of the upper wind shield, and the plurality of upper guide vanes are circumferentially distributed around a partial circumference of a periphery of the upper central hole; the lower end portion fan includes a lower wind shield and a plurality of lower guide vanes protruding from the lower wind shield, a lower central hole is provided at the center of the lower wind shield, a plurality of ventilation holes are further provided in the lower wind shield, and the plurality of ventilation holes and the plurality of lower guide vanes are circumferentially distributed around a periphery of the lower central hole; and the plurality of upper guide vanes and the plurality of lower guide vanes both face the stator assembly and are staggered in a circumferential direction, so that when the upper end portion fan and the lower end portion fan rotate together with the external rotor assembly, air circulation is formed between an upper end and a lower end inside the motor. The upper end portion fan and the lower end portion fan add a new heat circulation loop to the cavity. The upper end portion fan and the lower end portion fan draws out heat in the stator assembly from the stator assembly through winding slot gaps to enhance the heat transfer effect, thereby effectively solving failure risks caused by non-uniform temperature rise in stator windings; no ventilation holes are opened outside the motor, thereby ensuring the protection performance of the motor; and the upper end portion fan and the lower end portion fan have simple structures and low costs.

2. Other advantages of the present invention are described in detail in the embodiment part.

### BRIEF DESCRIPTION OF THE DRAWINGS

FIG. 1 is a schematic diagram of heat transfer inside an external rotor motor in the related art;

FIG. 2 is a schematic structural diagram of an external rotor motor according to an embodiment of the present invention;

FIG. 3 is a side view of an external rotor motor;

FIG. 4 is a cross-sectional view along A-A in FIG. 3;

FIG. 5 is a cross-sectional view along B-B in FIG. 3;

FIG. 6 is an enlarged view of C in FIG. 5;

FIG. 7 is an exploded view of an external rotor assembly of an external rotor motor;

FIG. 8 is an exploded view of an external rotor assembly from another perspective;

FIG. 9 is a schematic structural diagram of an upper end portion fan of an external rotor motor;

FIG. 10 is a schematic structural diagram of a lower end portion fan of an external rotor motor;

FIG. 11 is a schematic structural diagram of a bearing seat of an external rotor motor; and

FIG. 12 is a schematic diagram of heat conduction inside an external rotor motor.

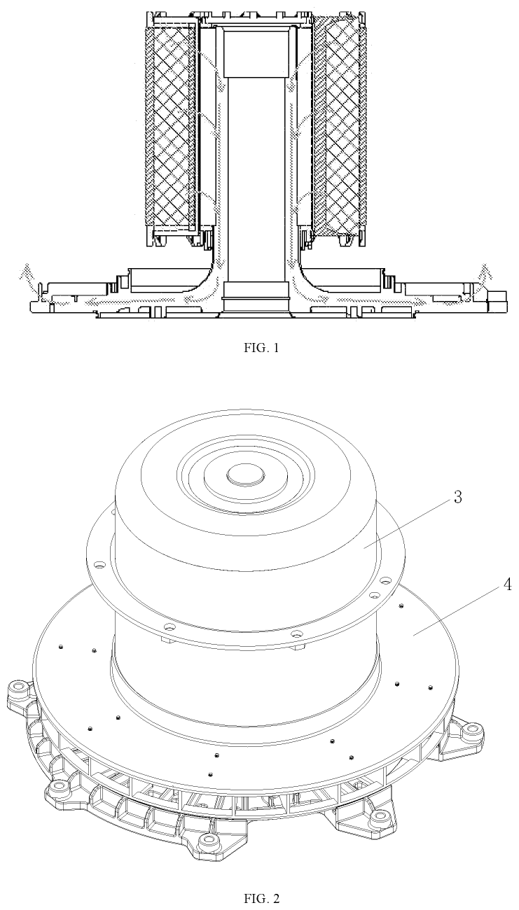

### DETAILED DESCRIPTION

In order to make the objectives, technical solutions and advantages of the embodiments of the present invention clearer, the technical solutions in the embodiments of the present invention will be clearly and completely described below in conjunction with the accompanying drawings in the embodiments of the present invention. Obviously, the described embodiments are some of the embodiments of the present invention, rather than all of the embodiments. All other embodiments obtained by persons of ordinary skill in the art based on the embodiments of the present invention without creative efforts fall within the protection scope of the present invention.

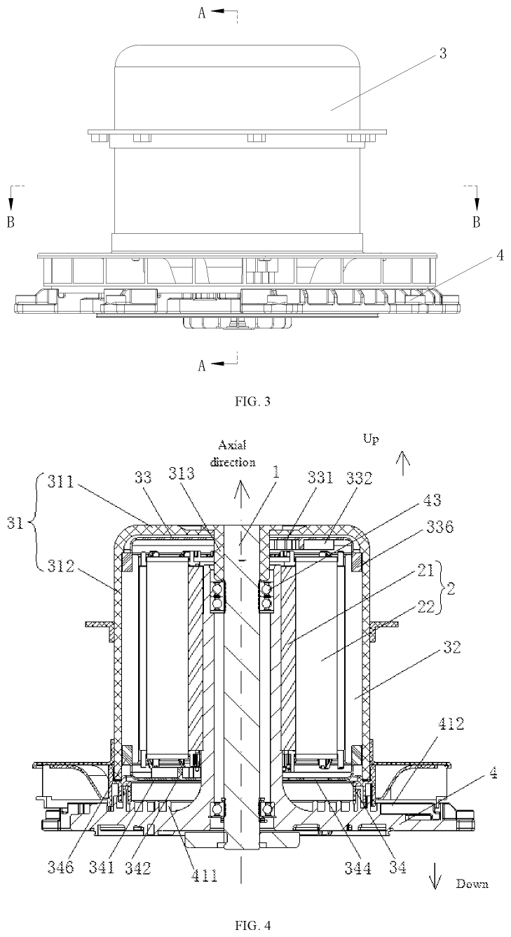

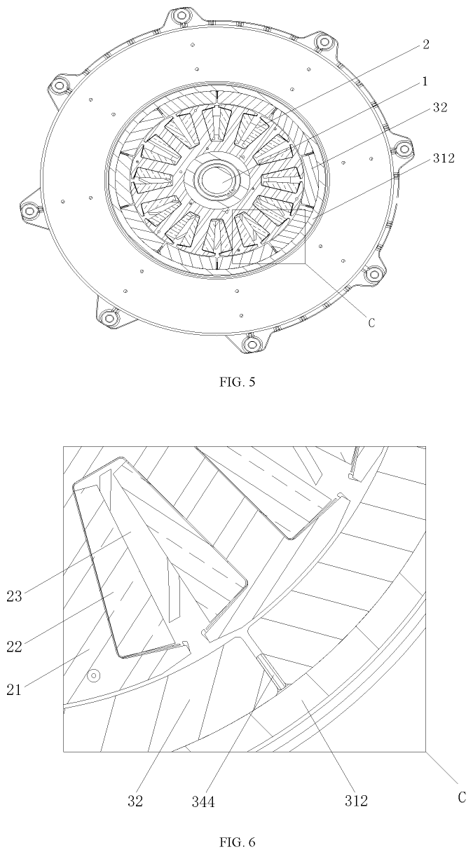

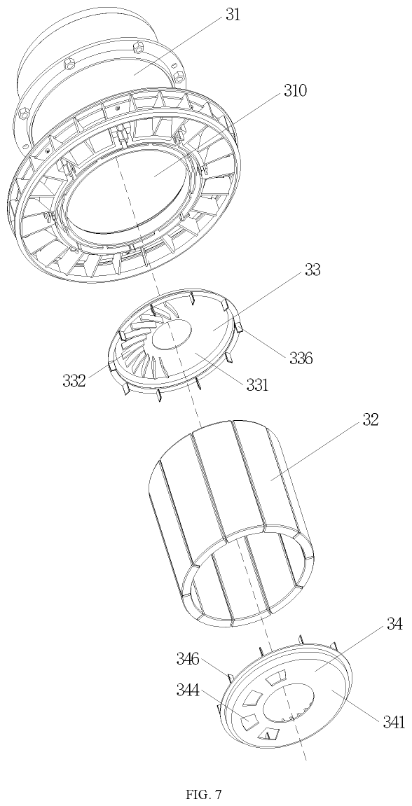

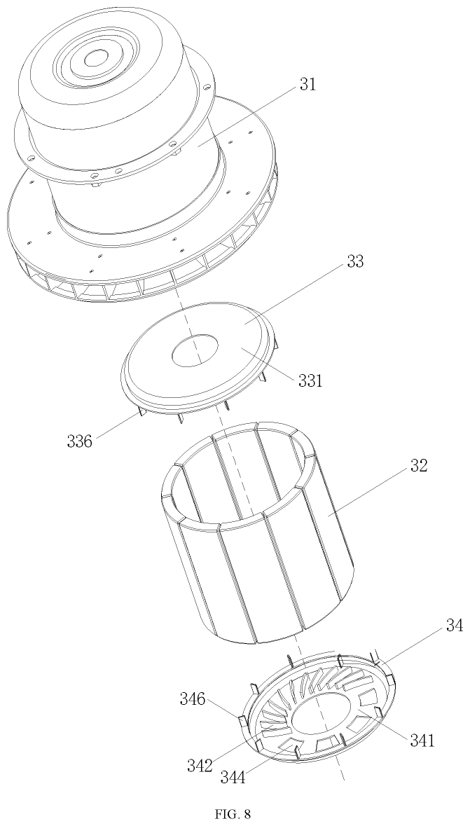

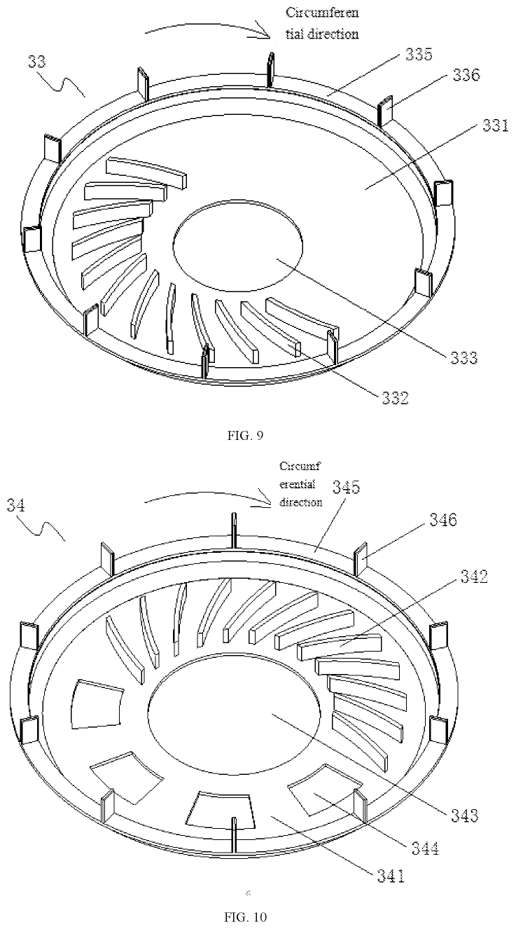

As shown in FIG. 2 to FIG. 11, this embodiment provides an external rotor motor, including a rotation shaft 1, a stator assembly 2, an external rotor assembly 3, and a bearing seat 4, where the bearing seat 4 includes a bottom plate 41 and a sleeve 42 protruding upward from the center of the bottom plate 41, a bearing 43 is mounted inside the sleeve 42, the rotation shaft 1 is supported on the bearing 43, the stator assembly 2 is sheathed and mounted on an exterior of the sleeve 42, the external rotor assembly 3 is sleeved around an exterior of the stator assembly 2, the external rotor assembly 3 includes a housing 31, the housing 31 includes a top plate 311 and a cylindrical side plate 312 that are connected together, a plurality of permanent magnets 32 are mounted on an inner wall surface of the cylindrical side plate 312, the top plate 311 and the cylindrical side plate 312 enclose a cavity 310, the stator assembly 2 is located in the cavity 310, an end of the rotation shaft 1 is connected to the top plate 311, and an upper end portion fan 33 and a lower end portion fan 34 are respectively mounted on an upper side and a lower side of the permanent magnets 32;
the upper end portion fan 33 includes an upper wind shield 331 and a plurality of upper guide vanes 332 protruding from the upper wind shield 331, an upper central hole 333 is provided at the center of the upper wind shield 331, and the plurality of upper guide vanes 332 are circumferentially distributed around a partial circumference of a periphery of the upper central hole 333; the lower end portion fan 34 includes a lower wind shield 341 and a plurality of lower guide vanes 342 protruding from the lower wind shield 341, a lower central hole 343 is provided at the center of the lower wind shield 341, a plurality of ventilation holes 344 are further provided in the lower wind shield 341, and the plurality of ventilation holes 344 and the plurality of lower guide vanes 342 are circumferentially distributed around a periphery of the lower central hole 343; and
the plurality of upper guide vanes 332 and the plurality of lower guide vanes 342 both face the stator assembly 2 and are staggered in a circumferential direction, so that when the upper end portion fan 33 and the lower end portion fan 34 rotate together with the external rotor assembly 3, air circulation is formed between an upper end and a lower end inside the motor to accelerate cooling.

The stator assembly 2 includes a stator core 21 and coil windings 22. A winding slot gap 23 is formed between every two adjacent coil windings 22.

In the external rotor motor in this embodiment, a new heat circulation loop is added to the cavity 310. The upper end portion fan 33 and the lower end portion fan 34 draws out heat from the stator assembly 2 through the winding slot gaps 23 of the stator assembly 2 to enhance the heat transfer effect, thereby effectively solving failure risks caused by non-uniform temperature rise in stator windings; no ventilation holes are opened outside the motor, thereby ensuring the protection performance of the motor; and the upper end portion fan 33 and the lower end portion fan 34 have simple structures and low costs.

An upper flange ring 335 protrudes axially from an edge of the upper wind shield 331, and a plurality of circumferentially spaced upper inserts 336 protrude axially from a surface of the upper flange ring 335; a lower flange ring 345 protrudes axially from an edge of the lower wind shield 341, and a plurality of circumferentially spaced lower inserts 346 protrude axially from a surface of the lower flange ring 345; and every two adjacent permanent magnets 32 are separated by one upper insert 336 and one lower insert 346, and the upper end portion fan 33 and the lower end portion fan 34 are located in the cavity 310. The upper inserts 336 and the lower inserts 346 make the mounting of the upper end portion fan 33 and lower end portion fan 34 convenient and reliable.

The plurality of upper guide vanes 332 are circumferentially distributed around a 180-degree partial circumference of the periphery of the upper central hole 333, and the remaining 180-degree partial circumference of the periphery of the upper central hole 333 is void of vanes; and the plurality of lower guide vanes 342 are circumferentially distributed around a 180-degree partial circumference of the periphery of the lower central hole 343, and the plurality of ventilation holes 344 are distributed around the remaining 180-degree partial circumference of the periphery of the lower central hole 343.

A mounting seat 313 protrudes from the center of the top plate 311 to the cavity 310, and the end of the rotation shaft 1 extends from the sleeve 42 to be connected to the mounting seat 313.

At least two ventilation holes 344 are provided, making the air circulation in the external rotor assembly 3 smoother.

The upper guide vanes 332 and the lower guide vanes 342 have opposite curvature directions, thereby further facilitating the guidance of heat.

Specifically, the upper guide vanes 332 are curved counterclockwise, and the lower guide vanes 342 are curved clockwise.

A plurality of cooling ribs 41 protrude from the bottom plate.

The cooling ribs include internal cooling ribs 411 and external cooling ribs 412, the internal cooling ribs 411 are located under the housing 31, the external cooling ribs 412 are located at a periphery of the internal cooling ribs 411, and the internal cooling ribs 411 are shaped in a plurality of concentric circles with the sleeve 42 as the center thereof. Because the ventilation holes 344 of the lower end portion fan 34 rotate to form circumferentially varying cooling airflow, the circular cooling ribs can further increase contact areas between the airflow and the internal cooling ribs 411, thereby improving cooling efficiency. The plurality of cooling ribs are disposed at the bottom of the bearing seat 4. Hot air blown by the upper end portion fan 33 and the lower end portion fan 34 is guided to the plurality of cooling ribs disposed at the bottom of the bearing seat 4. Heat is transferred to the external cooling ribs of the motor, and is then conducted outside the motor.

The positions of the ventilation holes 344 in the lower end portion fan 34 rotate with an external rotor, and therefore form circumference varying cooling airflow. Therefore, the internal cooling ribs 411 distributed around the circumference are provided inside the motor to increase the contact areas between the airflow and the internal cooling ribs 411, thereby improving cooling efficiency. The external cooling ribs 412 outside conduct heat from the interior to the exterior, and therefore the external cooling ribs 412 outside the motor are evenly arranged vertically and in the circumferential direction, to conduct out heat as much as possible.

The plurality of external cooling ribs 412 are arranged to extend radially with the sleeve 42 as the center thereof. The radial external cooling ribs 412 can better conduct out heat from the internal cooling ribs 411, thereby further enhancing the cooling effect.

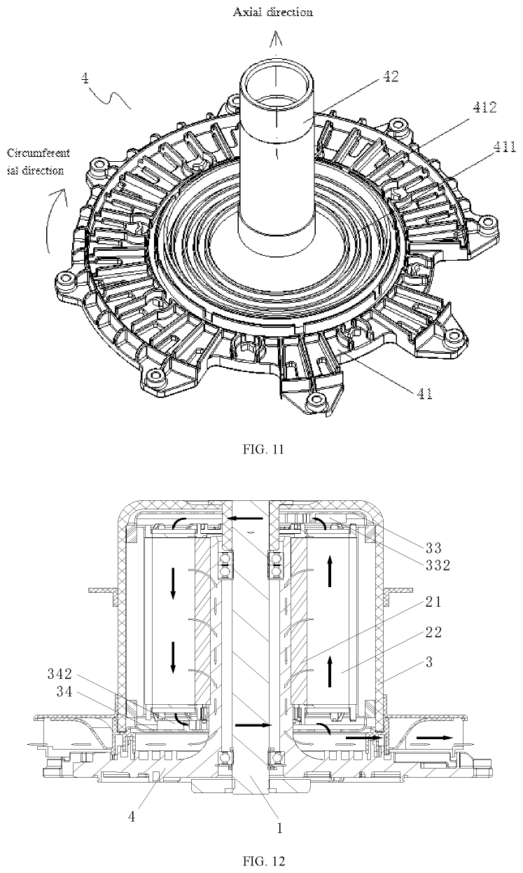

As shown in FIG. 12, for the external rotor motor in this embodiment, internal air flows along two paths: (1) a heat transfer path (which is represented by hollow arrows in the figure, and is a contact heat transfer path) in the related art: heat of the stator assembly 2 is transferred to the bottom plate 41 through the sleeve 42 and is then transferred outside the motor; (2) a heat transfer path (which is represented by solid arrows in the figure, and is an air transfer path) added in this embodiment: the upper guide vanes 332 draw heat of hot air inside the stator assembly 2 upward from the winding slot gaps and guide the heat to a vaneless region of the upper wind shield 331. Below the stator assembly 2, the lower guide vanes 342 draw out heat inside the stator assembly 2 and heat below the upper wind shield 331 through the winding slot gaps and then guide the heat to a vaneless region in the lower end portion fan 34. The heat contacts the cooling ribs at the bottom of the bearing seat through the ventilation holes 344, and is then conducted outside the motor.

The external rotor motor in this embodiment has a simple structure, an excellent cooling effect, and stable performance.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments or make equivalent replacements to some the technical features thereof, without departing from the spirit and scope of the technical solutions of the embodiments of the present invention.

1. An external rotor motor, comprising a rotation shaft (1), a stator assembly (2), an external rotor assembly (3), and a bearing seat (4), wherein the bearing seat (4) comprises a bottom plate (41) and a sleeve (42) protruding upward from the center of the bottom plate (41), a bearing (43) is mounted inside the sleeve (42), the rotation shaft (1) is supported on the bearing (43), the stator assembly (2) is sheathed and mounted on an exterior of the sleeve (42), the external rotor assembly (3) is sleeved around an exterior of the stator assembly (2), the external rotor assembly (3) comprises a housing (31), the housing (31) comprises a top plate (311) and a cylindrical side plate (312) that are connected together, a plurality of permanent magnets (32) are mounted on an inner wall surface of the cylindrical side plate (312), the top plate (311) and the cylindrical side plate (312) enclose a cavity (310), the stator assembly (2) is located in the cavity (310), an end of the rotation shaft (1) is connected to the top plate (311), and an upper end portion fan (33) and a lower end portion fan (34) are respectively mounted on an upper side and a lower side of the permanent magnets (32);
the upper end portion fan (33) comprises an upper wind shield (331) and a plurality of upper guide vanes (332) protruding from the upper wind shield (331), an upper central hole (333) is provided at the center of the upper wind shield (331), and the plurality of upper guide vanes (332) are circumferentially distributed around a partial circumference of a periphery of the upper central hole (333);
the lower end portion fan (34) comprises a lower wind shield (341) and a plurality of lower guide vanes (342) protruding from the lower wind shield (341), a lower central hole (343) is provided at the center of the lower wind shield (341), a plurality of ventilation holes (344) are further provided in the lower wind shield (341), and the plurality of ventilation holes (344) and the plurality of lower guide vanes (342) are circumferentially distributed around a periphery of the lower central hole (343); and
the plurality of upper guide vanes (332) and the plurality of lower guide vanes (342) both face the stator assembly (2) and are staggered in a circumferential direction, so that when the upper end portion fan (33) and the lower end portion fan (34) rotate together with the external rotor assembly (3), air circulation is formed between an upper end and a lower end inside the motor to accelerate cooling.

2. The external rotor motor according to claim 1, wherein an upper flange ring (335) protrudes axially from an edge of the upper wind shield (331), and a plurality of circumferentially spaced upper inserts (336) protrude axially from a surface of the upper flange ring (335);
a lower flange ring (345) protrudes axially from an edge of the lower wind shield (341), and a plurality of circumferentially spaced lower inserts (346) protrude axially from a surface of the lower flange ring (345); and
every two adjacent permanent magnets (32) are separated by one upper insert (336) and one lower insert (346), and the upper end portion fan (33) and the lower end portion fan (34) are located in the cavity (310).

3. The external rotor motor according to claim 1, wherein the plurality of upper guide vanes (332) are circumferentially distributed around a 180-degree partial circumference of the periphery of the upper central hole (333), and the remaining 180-degree partial circumference of the periphery of the upper central hole (333) is void of vanes; and the plurality of lower guide vanes (342) are circumferentially distributed around a 180-degree partial circumference of the periphery of the lower central hole (343), and the plurality of ventilation holes (344) are distributed around the remaining 180-degree partial circumference of the periphery of the lower central hole (343).

4. The external rotor motor according to claim 3, wherein a mounting seat (313) protrudes from the center of the top plate (311) to the cavity (310), and the end of the rotation shaft (1) extends from the sleeve (42) to be connected to the mounting seat (313).

5. The external rotor motor according to claim 4, wherein at least two ventilation holes (344) are provided.

6. The external rotor motor according to claim 4, wherein the upper guide vanes (332) and the lower guide vanes (342) have opposite curvature directions.

7. The external rotor motor according to claim 6, wherein a plurality of cooling ribs protrude from the bottom plate (41).

8. The external rotor motor according to claim 7, wherein the cooling ribs comprise internal cooling ribs (411) and external cooling ribs (412), the internal cooling ribs (411) are located under the housing (31), the external cooling ribs (412) are located at a periphery of the internal cooling ribs (411), and the internal cooling ribs (411) are shaped in a plurality of concentric circles with the sleeve (42) as the center thereof.

9. The external rotor motor according to claim 8, wherein the plurality of external cooling ribs (412) are arranged to extend radially with the sleeve (42) as the center thereof.

10. The external rotor motor according to claim 2, wherein the plurality of upper guide vanes (332) are circumferentially distributed around a 180-degree partial circumference of the periphery of the upper central hole (333), and the remaining 180-degree partial circumference of the periphery of the upper central hole (333) is void of vanes; and the plurality of lower guide vanes (342) are circumferentially distributed around a 180-degree partial circumference of the periphery of the lower central hole (343), and the plurality of ventilation holes (344) are distributed around the remaining 180-degree partial circumference of the periphery of the lower central hole (343).
